(19) United States
(12) Patent Application Publication
(10) Pub. No.: US 2006/0017280 A1
(43) Pub. Date: Jan. 26, 2006

(54) Pipe repair system and device

(76) Inventor: Jean Maureen Ball, Darlington (GB)

Correspondence Address: GREENSFELDER HEMKER & GALE PC, SUITE 2000, 10 SOUTH BROADWAY, ST LOUIS, MO, 63102, US

(21) Appl. No.: 10/511,066

(22) PCT Filed: Apr. 8, 2003
(86) PCT No.: PCT/GB03/01509

§ 371 Date: Jun. 1, 2005

(30) Foreign Application Priority Data
Apr. 9, 2002 (GB) 0208098.4

(51) Int. Cl. F16L 55/18

(52) U.S. Cl. 285/15

(57) ABSTRACT

The invention provides a coupling member for use in the repair of pipes and pipelines of from 90 mm to 250 mm in diameter, such as those used for the pipeline transportation and delivery of domestic and industrial liquids such as water, gas, oil and other petrochemicals. Two coupling members are used for each repair. Each has a first collar portion for surrounding the new pipe section and a second collar portion for surrounding a cut end portion of the old pipe section, and the two pipe connectors are located with their respective first collar portions adjacent to one another and their respective second collar portions facing mutually outwardly towards the opposite ends of the new pipe section. Pressure chambers are formed between the annular grooves and the seal members of the first collar portions and between the annular grooves and the nitrile rubber sealing rings of the second collar portions.

### FIELD OF THE INVENTION

The invention relates to a system and device for the quick and permanent repair of burst sections of pipe carrying household and/or industrial fluids such as water, gas, oil and other petrochemicals.

### BACKGROUND ART

The above household and/or industrial fluids are normally transported underground or above ground in pipelines having pipe sizes of from 90 mm to 250 mm. The pipes are typically made from plastic, steel or ductile iron, and the fluids can be transported under pressure, typically at pressures up to 100 BAR. Particularly when the pipe is laid underground, there is a high risk of pipe rupture due to corrosion (especially in the case of metal pipes) or ground movement. In climates suffering extremes of temperature, there is also the possibility of frost damage causing pipe rupture. In all cases when a pipe or pipeline bursts, it is necessary to effect a repair as quickly as possible. Ideally the repair should be one that is permanent, so that particularly in the case of an underground pipe, the site does not have to be re-excavated at a future date to convert a temporary repair into a permanent one.

This invention is based on a modification of a pipe coupling as described and illustrated in our European Patent Specification No. EP-B-727026. That Patent describes a coupling for the pipes, whereby an annular array of arcuate grippers is clamped around the outside of an end portion of a pipe by the application of hydraulic pressure, and a rubber seal in the form of an O-ring is received in an annular groove extending through the annular array and placed in compression between the grippers and the external diameter of the pipe.

Our European Patent Application No. EP-B-998643 discloses a variant of the above coupling using a wide tolerance gripper, so that the coupling can be fixed to the end portions of pipes of different external diameters, and can accommodate a difference in diameters up to about 25 mm.

Both of the above patented pipe couplings are suitable primarily for new pipes with a smooth external diameter. If a pipe has been underground or exposed to the elements for a considerable period, then its external diameter can be very uneven. Some ductile iron pipes that have been buried underground for a large number of years, for example, can have surface rust presenting a flaky, uneven and unstable exterior surface to a depth of almost 15 mm.

It is an object of the invention to provide a repair system, and a pipe connector for use in such a repair system, which is capable of dealing with the above problems and effecting a rapid and permanent repair to a burst pipe in a variety of extreme situations where either access is too limited for a conventional repair to be carried out readily or surface corrosion of the burst pipe to be repaired is such that conventional repair systems could not be contemplated.

### THE INVENTION

The invention provides a pipe connector for repairing a burst pipe, comprising a sleeve for encircling adjacent facing ends of old and new pipe sections, the sleeve having a first collar portion for surrounding and establishing an external seal with the end of the new pipe section and a second collar portion for surrounding and establishing an external seal with the end of the old pipe section, wherein:
the first collar portion has an annular internal recess receiving a circular array of arcuate gripper members to surround the new pipe section, an actuating member contacting the circular array of arcuate gripper members internally of the recess and defining, within the recess, a pressure chamber to which fluid under pressure can be applied to move the actuating member to urge the arcuate gripper members against the external diameter of the new pipe section, and sealing means responsive to fluid under pressure in the pressure chamber for sealing against the external diameter of the new pipe section;
and wherein the second collar portion has an annular internal recess receiving a nitrile rubber annular sealing member which defines, within the recess, a pressure chamber to which fluid under pressure can be applied to urge the nitrile rubber sealing member to move radially inwardly into sealing engagement with the external diameter of the old pipe section.

The formation of the first collar portion of the pipe connector of the invention is as defined in EP-B-727026 or EP-B-998643. Pressurisation of the hydraulic fluid in the first pressure chamber causes the array of arcuate gripper members to move against and physically to grip the outer periphery of the new pipe section. The gripper members resist the axial movement of the pipe connector along the new pipe section, and are essential to secure the pipe connector to that new pipe section. In the construction of E-B-727026 the sealing means responsive to fluid under pressure in the pressure chamber is an O-ring located in an annular recess located in an internally facing groove spanning the circular array of gripper members and compressed, in use, between the gripper members and the outside diameter of the new pipe section and optionally also against a side wall of the recess. In the construction of EP-B-998643 the actuating member contacting the circular array of gripper members preferably comprises a nitrile rubber sealing ring and the sealing means for sealing against the external diameter of the new pipe section preferably is a portion of that sealing ring which on pressurisation extrudes radially inwardly against the pipe external diameter.

The second collar portion contains no such arcuate gripper members. All that is received in the annual internal recess in the second collar portion is a circular sealing member moulded from nitrite rubber, and application of high pressure grease to the hydraulic chamber established between the recess and the rubber sealing member is sufficient to cause the nitrile rubber sealing member to move into sealing contact against the external diameter of the old pipe section. The hydraulic pressure applied to compress the nitrite rubber sealing member against the external diameter of the old pipe section is preferably from 3000 to 8000 psi (2×10⁷ to 5.5×10⁷ pascals). At such high pressures, the nitrile rubber tends to extrude radially inwardly from the annual recess in which it is initially contained, and adopts a temporary semi-fluid characteristic which enables it to flow into, and there seal, any surface irregularities of the outside diameter of the old pipe around which the pipe connector is placed. An effective seal is therefore established between the pipe connector and the old pipe, but unlike the sealing between the first collar portion and the new pipe, the sealing between the second collar portion and the old pipe has no gripping component to restrain axial movement of the pipe connector relative to the old pipe. For reasons explained below, that is not a disadvantage and does in fact contribute to the effectiveness of the pipe repairs effected using the pipe connector.

The invention also provides a pipe repair system utilising two pipe connectors according to the invention. First of all a burst portion of an existing pipeline is identified and located. Then the burst section of the pipe is cut away, leaving two preferably square planar cut ends of the old pipe facing each other and separated by the length of the removed portion of the burst pipe. That cut-away portion is then replaced by an identical length of a new pipe section having a similar internal diameter. Onto this new pipe section there have been pre-located two pipe connectors according to the invention, with their respective first collar portions adjacent to one another and their respective second collar portions facing mutually outwardly towards the opposite ends of the new pipe section. The cut-away burst pipe section and the new pipe section must therefore be of an axial length at least equal to that of the two pipe connectors.

With the new pipe section being held temporarily in line with the old pipe and filling the gap caused by cutting out and removing the burst section of pipe, the two pipe connectors are then moved mutually apart until each straddles the junction between old and new pipe sections, and high pressure grease is applied first to the pressure chambers of the first collar portions so as to move the arcuate gripper members into gripping engagement with the first pipe section, and to establish a seal against the external diameter of the new pipe section by compression of the sealing means against that outer diameter. Subsequently hydraulic pressure is applied to the pressure chambers formed in the second collar portions of the pipe connectors, so that the nitrile sealing members contained in the annular recesses of the second collar portions are forced to extrude radially inwardly from the recesses of the second collar portions and into firm sealing contact with the external diameter of the old pipe section. At the hydraulic pressures contemplated, the nitrile rubber flows quietly evenly and naturally into all small crevices contained in the outer diameter of the old pipe sections, adopting many of the flow characteristics of a fluid to create and maintain good sealing contact around the entire outer periphery of the old pipe sections.

The aspect ratio (radial depth to width) of the nitrile rubber sealing member is preferably of the order of 2:1, permitting the pipe connectors to be used with old pipe sections of a variety of sizes and in a variety of corroded conditions. By eliminating the grippers which were present in the first collar portion, the pipe connectors of the invention are of simpler construction than those of EP-B-727026 and EP-B-998643 and, much more importantly, the pipe connectors of the invention can be used to effect in situ repairs of a number of pipelines of different external diameters and in different stages of corrosion or decay. In the absence of gripper members associated with the second collar portion, the annular seal can extrude freely outwardly against the old pipe sections, while the gripper members associated with the first collar portions are effective securely to anchor the pipe connectors against axial movement. Significant tolerances, even radial gaps of up to 28 mm, can be accommodated between the second collar portions and the old pipe sections, since the inwardly extruded nitrile rubber seals can span and fill gaps up to that size.

### DRAWINGS

FIG. 1 is an end view of a pipe connector according to the invention;

FIG. 2 is an axial section through the coupling of FIG. 1 taking along the plane A-A of FIG. 1;

FIG. 3 is a side elevation of a damaged pipe to be repaired according to this invention;

FIG. 4 is a side elevation of the pipe of FIG. 3 during repair; and

FIG. 5 is a side elevation of the repaired pipe of FIG. 3.

### DESCRIPTION OF PREFERRED EMBODIMENTS OF THE INVENTION

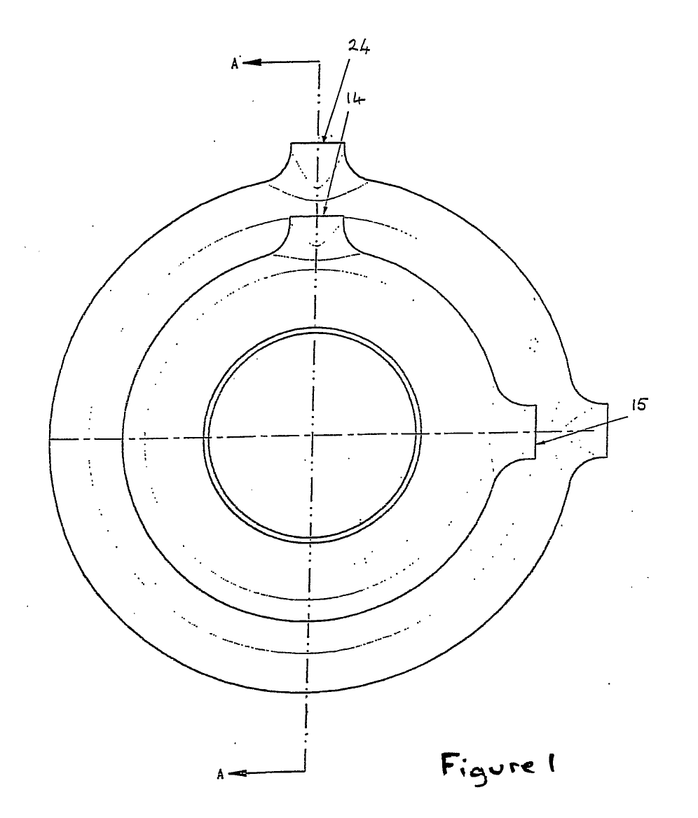

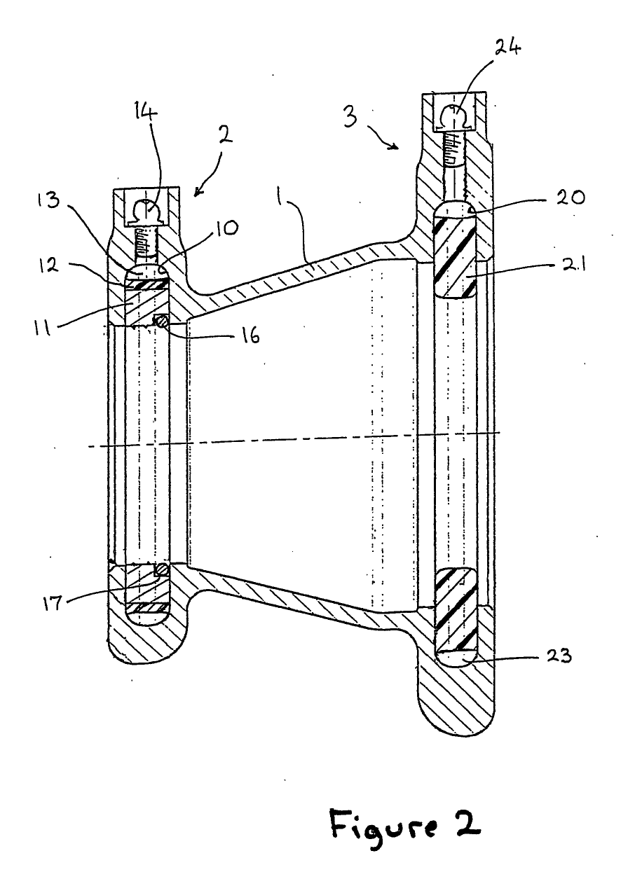

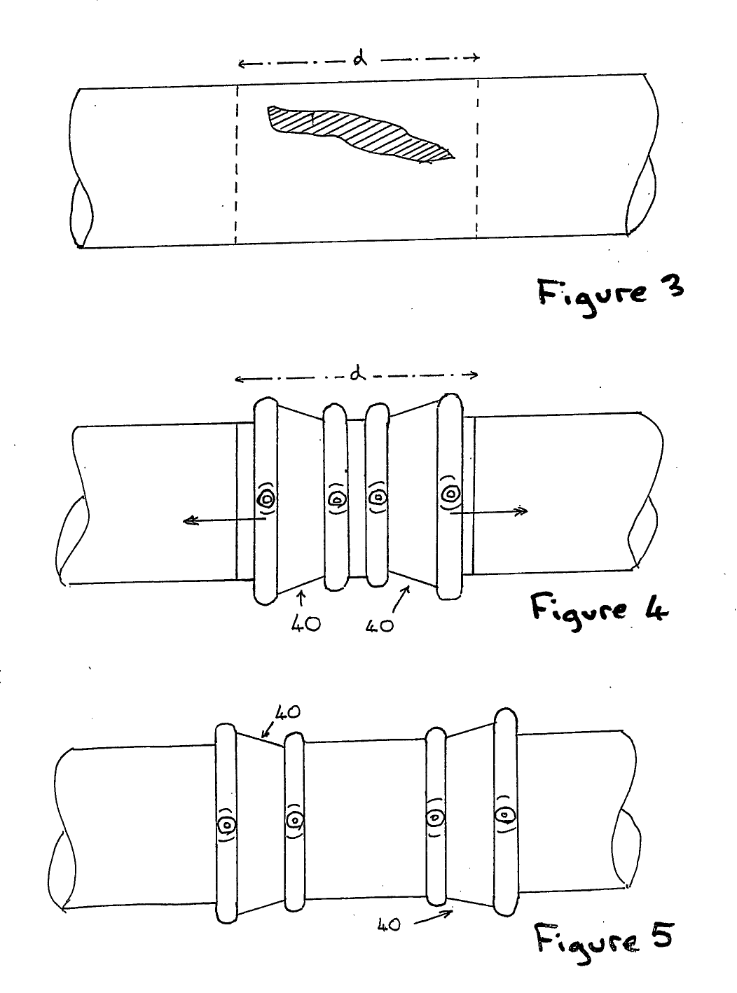

The coupling of FIGS. 1 and 2 comprises a sleeve portion 1 which is generally frustoconical in shape and extends from a first collar portion 2 to a second collar portion 3. The first collar portion 2 is for surrounding a new pipe section in use, and is as described in European Patent No. EP-B-727026. An annular groove 10 is formed on the internal surface of the collar 2 and houses a circular array of arcuate gripper members 11 surrounded by a sealing member 12. Between the sealing member 12 and the internal periphery of the groove 10 is formed a hydraulic chamber 13 which can be pressurised by the application of high pressure grease through a grease nipple 14. A release valve 15 offset by 90° from the grease nipple 14 permits release of the pressure from the hydraulic chamber 13 should that be necessary. An array of arcuate shims (not shown) is provided between the sealing member 12 and the arcuate gripper members 11, each shim bridging the gap between adjacent arcuate gripper members so as to prevent the sealing member 12 from extruding downwards between adjacent gripper members on the application of hydraulic pressure to the grease within the hydraulic chamber 13.

The internal peripheral surfaces of the gripper members 11 are toothed so that when high pressure grease is applied to the hydraulic chamber 13, the gripper members bite into the external surface of the pipe section around which the pipe connector is placed, preventing axial movement of the pipe connector relative to that pipe section.

A fluid seal is established between the first collar portion 2 of the pipe connector and the pipe section around which it is placed by virtue of an O-ring seal 16 located in an annular recess 17 spanning the internal peripheries of all of the arcuate gripper members 11. When the gripper members 11 are forced against and bite into the outer peripheral surface of a pipe section, the O-ring seal 16 is compressed within its annular recess 17, to establish a reliable fluid seal between the pipe connector and the pipe section.

The second collar portion 3 of the pipe connector has a similar annular recess 20 formed. around the internal periphery of the collar portion, The recess 20 receives a nitrile rubber sealing ring 21 which has an aspect ratio (radial depth to width) of about 2:1. There are no grippers. A hydraulic chamber 23 is formed radially outwardly of the seal 21, and when pressurised for example by the application of high pressure grease through a grease nipple 24, the seal is forced to move radially inwardly into sealing contact with the external diameter of a pipe section about which the second collar portion 3 is placed. At the high pressures involved (3000 to 8000 psi, equivalent to 2×10⁷ to 5×10⁷ pascals) the extruding nitrile rubber adopts many of the flow characteristics of a liquid, and will flow into any surface imperfections in the pipe section around which the second collar portion is placed, and will also effectively span gaps between the second collar portion 3 and its associated pipe section.

FIGS. 3 to 5 illustrate the method of repair of a burst pipe using two pipe connectors according to the invention. First of all a section of damaged pipe is identified and exposed (FIG. 3). Then the damaged section is cut away by making two transverse cuts a distance d apart. A piece of new pipe of axial length d is then prepared, two pipe connectors 40. according to FIGS. 1 and 2 are sleeved onto that new pipe section back to back as shown in FIG. 4, and the new section is slipped into place between the cut ends of the original pipe. Finally the two connectors are slid axially apart, and their grease nipples pressurised until the gripper members 11 and O-ring seal 15 of the respective first collar portions 2 seal and grip against the ends of the new pipe section, and the sealing rings 21 of the respective second collar portions 3 seal against the respective end portions of the cut original pipe.

The repair is very simple and rapid. It is permanent, in that any excavation to expose the damaged pipe can be immediately back filled and does not have to be re-opened. The most difficult part of the repair is the cutting away of the damaged section, and provided sufficient access can be achieved for that cutting operation, the lowering into place of the new pipe section and the pressurisation of the four grease nipples can be accomplished rapidly and reliably with only the minimum of access restrictions being imposed on the person carrying out the repair.

1. A pipe connector for repairing a burst pipe, comprising a sleeve for encircling adjacent facing ends of old and new pipe sections, the sleeve having a first collar portion for surrounding and establishing an external seal with the end of the new pipe section and a second collar portion for surrounding and establishing an external seal with the end of the old pipe section:
wherein the first collar portion has an annular internal recess receiving a circular array of arcuate gripper members to surround the new pipe section, an actuating member contacting the circular array of arcuate gripper members internally of the recess and defining, within the recess, a pressure chamber to which fluid under pressure can be applied to move the actuating member to urge the arcuate gripper members against the eternal diameter of the new pipe section, and sealing means responsive to fluid under pressure in the pressure chamber for sealing against the external diameter of the new pipe section;
and wherein the second collar portion has an annular internal recess receiving a nitrile rubber annular sealing member which defines, within the recess, a pressure chamber to which fluid under pressure can be applied to urge the nitrile rubber sealing member to move radially inwardly into sealing engagement with the external diameter of the old pipe section.

2. A coupling according to claim 1, wherein the sealing means responsive to fluid under pressure in the pressure chamber is an O-ring located in an annular recess located in an internally facing groove spanning the circular array of gripper members and compressed, in use, between the gripper members and the outside diameter of the new pipe section and optionally also against a side wall of the recess.

3. A coupling according to claim 1, wherein the gripper members extend laterally down the side wall or walls of the groove in the first collar portion and across a part of the width of the groove as it opens towards the new pipe section; the actuating member contacting the circular array of gripper members comprises a nitrile rubber sealing ring; and the sealing means for sealing against the external diameter of the new pipe section is a portion of that sealing ring which on pressurisation extrudes radially inwardly past the gripper members and against the pipe external diameter.

4. A pipe connector for repairing a burst pipe, comprising a sleeve for encircling adjacent facing ends of old and new pipe sections, the sleeve having a first collar portion for surrounding and establishing an external seal with the end of the new pipe section and a second collar portion for surrounding and establishing an external seal with the end of the old pipe section:
wherein the first collar portion has an annular internal recess receiving a circular array of arcuate gripper members to surround the new pipe section, an actuating member contacting the circular array of arcuate gripper members internally of the recess and defining, within the recess, a pressure chamber to which fluid under pressure can be applied to move the actuating member to urge the arcuate gripper members against the eternal diameter of the new pipe section, and sealing means responsive to fluid under pressure in the pressure chamber for sealing against the external diameter of the new pipe section;
and wherein the second collar portion has an annular internal recess receiving a nitrile rubber annular sealing member which defines, within the recess, a pressure chamber to which fluid under pressure can be applied to urge the nitrile rubber sealing member to move radially inwardly into sealing engagement with the external diameter of the old pipe section, wherein the aspect ratio (radial depth to width) of the nitrile rubber sealing member is of the order of 2:1.

5. A coupling according to claim 1, wherein the sealing means responsive to fluid under pressure in the pressure chamber is an O-ring located in an annular recess located in an internally facing groove spanning the circular array of gripper members and compressed, in use, between the gripper members and the outside diameter of the new pipe section and optionally also against a side wall of the recess, and wherein the aspect ratio (radial depth to width) of the nitrile rubber sealing member is of the order of 2:1

6. A coupling according to claim 1, wherein the gripper members extend laterally down the side wall or walls of the groove in the first collar portion and across a part of the width of the groove as it opens towards the new pipe section; the actuating member contacting the circular array of gripper members comprises a nitrile rubber sealing ring; and the sealing means for sealing against the external diameter of the new pipe section is a portion of that sealing ring which on pressurisation extrudes radially inwardly past the gripper members and against the pipe external diameter, wherein the aspect ratio (radial depth to width) of the nitrile rubber sealing member is of the order of 2:1

7. A pipe repair method utilising two pipe connectors according to claim 1 for repairing a burst pipe which comprises the following process steps:
first a burst portion of an existing pipeline is identified and located;
then the burst section of the pipe is cut away, leaving two preferably square planar cut ends of the old pipe facing each other and separated by the length of the removed portion of the burst pipe;
then that cut-away pipe portion is replaced by an identical length of a new pipe section having a similar internal diameter, onto which there have been pre-located two pipe connectors according to the invention, with their respective first collar portions adjacent to one another and their respective second collar portions facing mutually outwardly towards the opposite ends of the new pipe section;
with the new pipe section being held temporarily in line with the old pipe and filling the gap caused by cutting out and removing the burst section of pipe, the two pipe connectors are then moved mutually apart until each straddles the junction between old and new pipe sections; and finally
high pressure grease is applied first to the pressure chambers of the first collar portions so as to move the arcuate gripper members into gripping engagement with the first pipe section, and to establish a seal against the external diameter of the new pipe section by compression of the sealing means against that outer diameter, and then to the pressure chambers formed in the second collar portions of the pipe connectors, so that the nitrile sealing members contained in the annular recesses of the second collar portions are forced to extrude radially inwardly from the recesses of the second collar portions and into firm sealing contact with the external diameter of the old pipe section.
